(19) United States
(12) Patent Application Publication
(10) Pub. No.: US 2017/0057418 A1
(43) Pub. Date: Mar. 2, 2017

(54) HOOK DEVICE FOR USE IN A VEHICLE

(71) Applicants: NEWFREY LLC, New Britain, CT (US); HAYASHI TELEMPU CORPORATION, Nagoya (JP)

(72) Inventors: Daisuke SHIBA, Toyohashi (JP); Takayuki HORIO, Nagoya (JP)

(73) Assignees: NEWFREY LLC, New Britain, CT (US); HAYASHI TELEMPU CORPORATION, Nagoya (JP)

(21) Appl. No.: 15/244,861

(22) Filed: Aug. 23, 2016

(30) Foreign Application Priority Data
Aug. 28, 2015 (JP) 2015-168650

(51) Int. Cl. B60R 7/04

(52) U.S. Cl. CPC B60R 7/04

(57) ABSTRACT

A hook case has a base; boxes which are formed on the back side of the base; and shaft holding members which are placed on the horizontal sides of the box. A hook has a body, a tang for hanging up baggage; and a hook shaft, and is capable of rotating between a housed position in the box and an in-use position in which the tang extends out of the box. The hook shafts have a first groove and a second groove. The shaft holding members of the case include case bearings which are provided on the back side of the base and which hold the hook shafts; and elastic tabs which engage in the first groove in the housed position, and in the second groove in the in-use position.

### CROSS-REFERENCE TO RELATED APPLICATIONS

This application claims the benefit and priority of Japanese Patent Application No. 2015-168650, filed Aug. 28, 2015, the entire disclosure of which is incorporated herein by reference.

### FIELD

The present disclosure pertains to a hook device for use in a vehicle which can be installed in a vehicle interior and used to hang baggage and the like.

### BACKGROUND

This section provides background information related to the present disclosure which is not necessarily prior art.

This kind of hook device for use in a vehicle is provided with a case and a hook which is rotatably supported on the case; when used, the hook projects in the in-use position for hanging up baggage, such as shopping bags and other bags having a handle. When not in use, the hook can be housed in a housed position.

In general, a hook device for use in a vehicle is provided with a locking mechanism. When the hook device for use in a vehicle is in use, the hook is locked so that the hook does not move from its in-use position; when the hook is not being used, the hook is locked so that it does not come out of its housed position.

If the locking mechanism for locking the hook is visible from the outside, however, existing hook devices for use in vehicles are not desirable, as regards their appearance. Also, the mechanism for locking the hook in the in-use position and the mechanism for locking the hook in the housed position are provided separately. As a result, the entire structure becomes complicated.

Patent Reference 1 (unexamined Patent Publication JP 2013-107566) discloses a hook device for use in a vehicle which is installed in the vehicle's interior and holds the handle of a shopping bag or the like. This hook device for use in a vehicle is provided with a base (the case) which is secured to an auto body and a hook which is rotatably supported on the base, which rotates between an extended position (the in-use position) and a housed position. In Patent Reference 1, the hook is rotated to the extended position, and once the handle of the shopping bag is hooked, the hook rotates to the housed position, and the hook is locked in the base, which makes it possible to prevent the handle from slipping from the hook.

In the hook device for use in a vehicle of Patent Reference 1, however, separate parts perform the locking in the extended position and the locking in the housed position. As a result, the locking mechanism is complicated. That is, in the extended position, a second stopper of the hook abuts the back surface of the frame of the base, and the hook is stopped in stable fashion. In the housed position, a locking protuberance of the hook abuts an elastic arm of the base, and a first stopper of the hook abuts a stopper receiving surface of the base, locking the hook.

These locking mechanisms are not provided on the shaft of the hook, and are instead provided on the outer circumference of the hook; as a result, the locking mechanism can be seen between the hook and the base.

Patent Reference 2 (unexamined Patent Publication JP 2006-046548) discloses a hook component which is attached in the luggage compartment of an automobile in order to suspend a metal fixture for hanging a net or the like which prevents baggage from moving. The hook component comprises a base frame with a recessed portion in the center; a hook member which is pivotally supported on a bearing on the base frame, which revolves between a housed position and an extended (in-use position); a cover member which is pivotally supported on the bearing of the base frame, which rotates between a closed configuration in which it hides a bolt head by entering into the recessed portion, and an upright configuration in which the bolt head is exposed; and a locking means which maintains the upright state of the cover member.

In Patent Reference 2, it is possible to completely hide the bolt head in the recessed portion of the base frame, which is desirable as regards its appearance. Also, the cover member is maintained in the upright state by the locking means, and, as a result, nothing hinders the operation of attaching the base frame to an attachment surface by means of a bolt.

In the hook component of Patent Reference 2 however, a separate component, that is, a cover member, is used to hide the inside. A leaf spring is used to produce a click sensation for the housed position and the extended position of the hook member. A projecting stopper of the hook abuts a receiving tab of a metal bracket, which controls the extended position of the hook member. In this fashion, a cover member and a leaf spring are used, resulting in many parts.

For this reason, a hook device for use in a vehicle is desired that looks attractive and in which the locking mechanism for locking the hook in the in-use position and in the housed position is not visible from the outside. In addition, a hook device for use in a vehicle is desired which has a simple locking mechanism in which the hook can be locked in both the in-use position and in the housed position by means of a single mechanism.

### SUMMARY

This section provides a general summary of the disclosure, and is not a comprehensive disclosure of its full scope or all of its features.

Accordingly, an object of the present disclosure is to offer a hook device for use in a vehicle in which the locking mechanism for locking the hook in the in-use position and in the housed position is not visible from the outside and looks attractive.

Another object of the present disclosure is to offer, by means of a single locking mechanism, a hook device for use in a vehicle which has a locking mechanism with a simple structure.

In order to solve these problems, one aspect of the present disclosure is a hook device for use in a vehicle comprises a case which has a base with a box formed on the back side of the base, and shaft holding members which are provided on the horizontal sides of the base; and a hook having a hook body and a tang for holding baggage, and a hook shaft which is held at the shaft holding members and which is capable of rotation around the hook shaft as a center shaft between a housed position in which it is housed in the box of the case, and an in-use position in which the tang extends out to hold baggage. The hook shaft has a first groove and a second groove which extend in the direction of the central axis of the hook shaft. The shaft holding members of the case are comprised of a case bearing which is provided on the back side of the base for receiving the hook shaft, and an elastic tab which can engage in the first groove or in the second groove of the hook shaft. The elastic tab engages in the first groove in the housed position, and engages in the second groove in the in-use position.

The hook device for use in a vehicle can be placed in a vehicle interior to hang up and hold the handle of baggage.

The hook device for use in a vehicle can have a box which houses the hook and the shaft holding members. It is also desirable from the standpoint of design that the hook has a hook shaft which is held on the hook shaft holding members, so that by rotating the hook, the hook can be housed in a box, so that the hook does not get in the way when not in use.

The hook shaft of the hook can have a first groove and a second groove, and the shaft holding members of the case can have elastic tabs which engage with the first groove to hold the hook in the housed position. Also, the elastic tabs can engage in the second groove to hold the hook in the in-use position.

By forming two grooves on the hook shaft of the hook, it is possible to combine and simplify the locking mechanism for the in-use position and the housed position on the shaft of the hook shaft.

The hook shaft can be positioned on the back side of the base, and as a result, the locking mechanism cannot be seen from the front even when the hook is in the in-use position or in the housed position, and this is desirable from the standpoint of design.

It is desirable to have the elastic tabs extend from the back side of the base at the shaft holding members to contact the hook shafts at positions other than those of the case bearings.

If the elastic tabs extend from the back side of the base and contact the shafts at positions other than those of the case bearings, the elastic tabs cannot be seen from the front, and this is desirable from the standpoint of design.

The shaft holding members of the case can have a pair of protuberances, and it is desirable that the protuberances hold the hook shafts from the side opposite the case bearings so that the hook shafts do not slip from the case bearings. If this pair of protuberances hold the hook shafts from the back side, the hook shafts do not slip from the case bearings. It is desirable for this pair of protuberances to hold the ends of the hook shafts.

If the protuberances are made to hold the ends of the hook shafts, the hook shafts can push and spread out the pair of protuberances when the hook shafts are pushed into the shaft holding members; and after the hook shafts enter the shaft holding members, the protuberances can return to their original positions and the hook shafts are held so that they do not slip from the case bearings.

It is desirable for the surface of the hook body of the hook to be higher than the surface of the base of the case when the hook is in the housed position.

When it is built into a vehicle, it is desirable for the surface of the base of the case to be covered by means of the deck side trim of the vehicle.

If the surface of the hook body is higher than the base of the case, it is possible to cover the surface of the base by means of the deck side trim of the vehicle, and only the hook can be seen, but not the base; and it is desirable from the standpoint of design to be able to make the surface of the hook body and the surface of the deck side trim coplanar.

It is desirable for the box of the case to have an upper box which has side surfaces and a back surface, and a lower box which has side surfaces but no back surface. If the upper box has a back surface, but the lower box has no back surface, the hook can be assembled in the case by inserting the hook from between the upper box and the lower box.

It is desirable for the case to have a stopper on the upper box and for the hook to have a stopper receiving member which the stopper abuts, so that when the hook is in the in-use position the stopper abuts the stopper receiving member and is held so that the hook does not rotate beyond the in-use position.

If the stopper abuts the stopper receiving member when the hook is in the in-use position, it is possible to hang up baggage that has some degree of weight.

It is desirable for a bolt aperture to be formed in the back surface of the upper box to allow a bolt to pass through. If a bolt aperture is formed in the back surface of the upper box, it is possible to attach the case to the auto body by passing a bolt through the bolt aperture.

According to the present disclosure, it is possible to offer a hook device for use in a vehicle that looks attractive and in which the locking mechanism for locking a hook in the in-use position and in the housed position is not visible from the outside.

Also, the present disclosure offers a hook device for use in a vehicle which has a simple locking mechanism.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front elevation view of the hook device for use in a vehicle according to an embodiment of the present disclosure.

FIG. 2 is a plan view of the hook of FIG. 1.

FIG. 3 is a right side view of the hook of FIG. 1.

FIG. 4 is a sectional view along line M-M in FIG. 3 of the hook in FIG. 1.

FIG. 5 is a sectional view along line L-L of the hook in FIG. 1.

FIG. 6 is a sectional view along line N-N in FIG. 2 of the hook in FIG. 1.

FIG. 7 is a front elevation view of the case of the hook device for use in a vehicle according to an embodiment of the present disclosure.

FIG. 8 is a plan view of the case of FIG. 7.

FIG. 9 is a right side view of the case of FIG. 7.

FIG. 10 is a sectional view along line Q-Q of the case of FIG. 7.

FIG. 11 is an enlarged view of the U portion in FIG. 9 of the case of FIG. 7.

FIG. 12 is a perspective view of the hook device for use in a vehicle according to an embodiment of the present disclosure.

FIG. 13 is a perspective view of the hook device for use in a vehicle of FIG. 12, viewed from another direction.

FIG. 14 is a front elevation view of the hook device for use in a vehicle of FIG. 12.

FIG. 15 is a right side view of the hook device for use in a vehicle of FIG. 12.

FIG. 16 is an enlarged view of portion A in FIG. 15 of the hook device for use in a vehicle of FIG. 12.

FIG. 17 is a rear view of the hook device for use in a vehicle of FIG. 12.

FIG. 18 is an enlarged view of portion D of FIG. 17 of the hook device for use in a vehicle of FIG. 12.

FIG. 19 is a sectional view along line B-B in FIG. 15 of the hook device for use in a vehicle of FIG. 12.

FIG. 20 is a sectional view along line C-C in FIG. 14 of the hook device for use in a vehicle of FIG. 12.

FIG. 21 is a sectional view along line G-G in FIG. 15 of the hook device for use in a vehicle of FIG. 12.

Corresponding reference numerals indicate corresponding parts throughout the several views of the drawings.

### DETAILED DESCRIPTION

Example embodiments will now be described more fully with reference to the accompanying drawings.

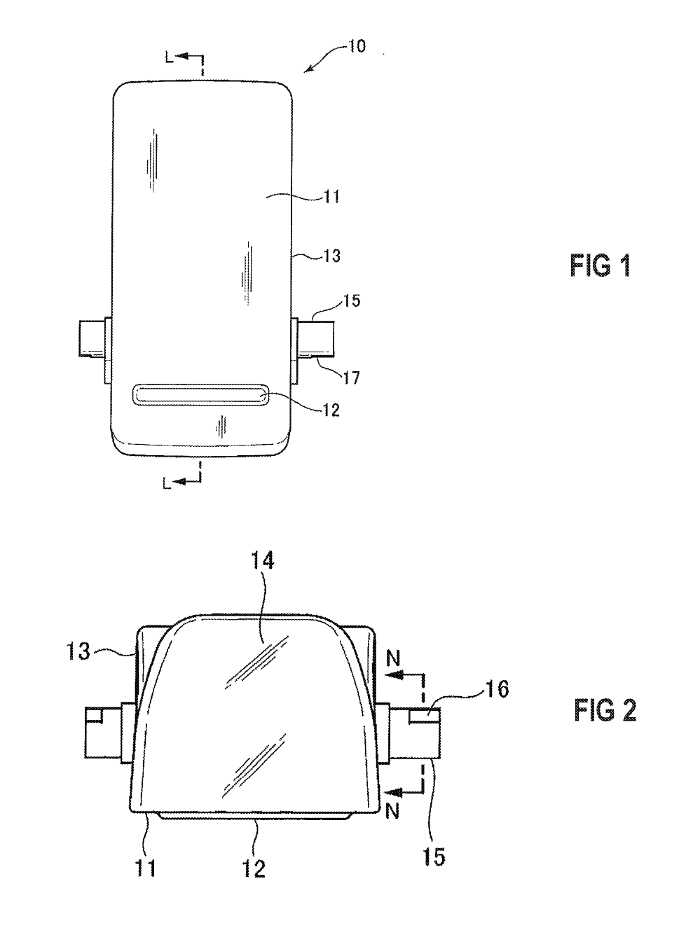

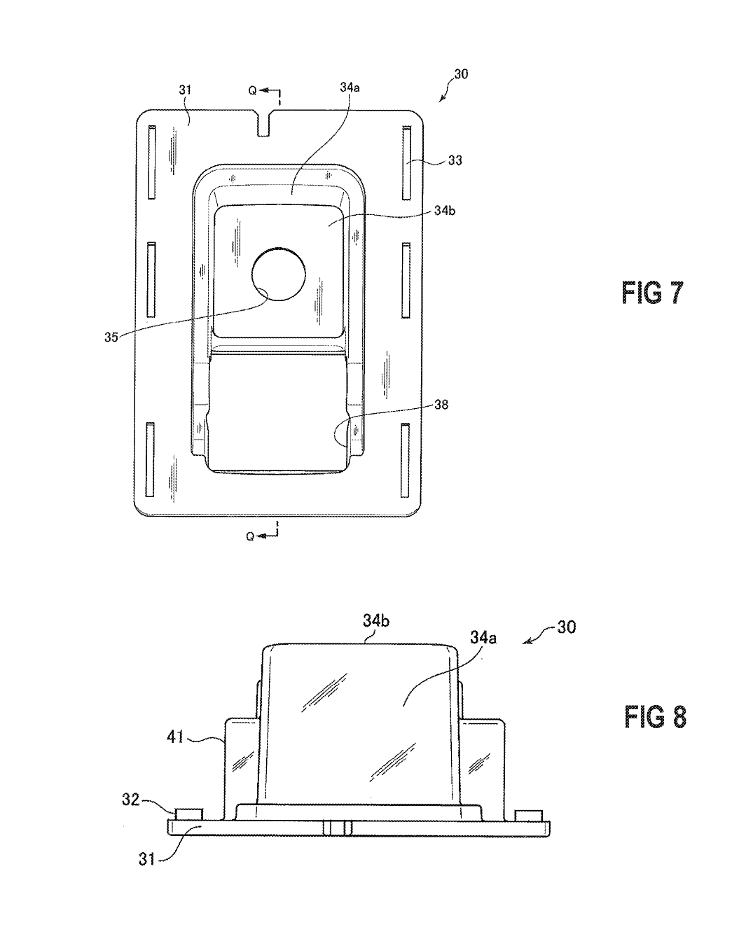

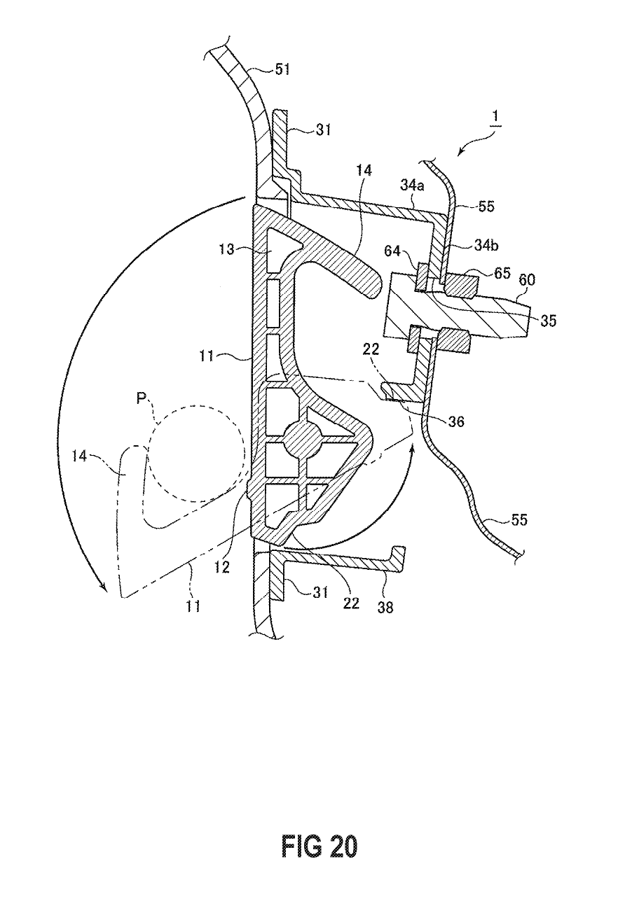

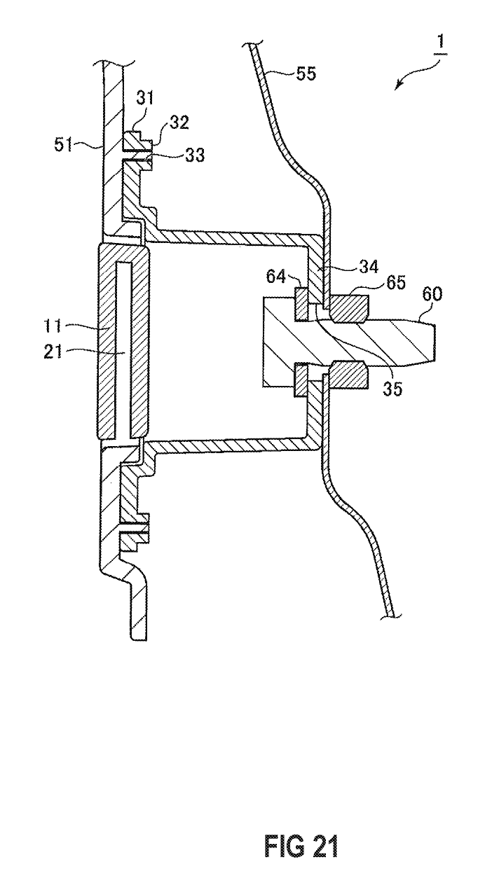

We shall next describe these embodiments by referring to the drawings. A hook device for use in a vehicle according to the present disclosure comprises a hook shown in FIGS. 1-6, and a case shown in FIGS. 7-11. As shown in FIGS. 12-19, hook 10 and case 30 when assembled form a hook device for use in a vehicle 1. As shown in FIG. 20 and in FIG. 21, the hook device for use in a vehicle 1 can be attached to body deck side trim.

We shall first explain hook 10 and case 30. We shall then explain a hook device for use in a vehicle 1 with an assembled hook 10 and case 30. The appropriate drawing of the hook device for use in a vehicle 1 will be used in the explanation of hook 10 and case 30 as well.

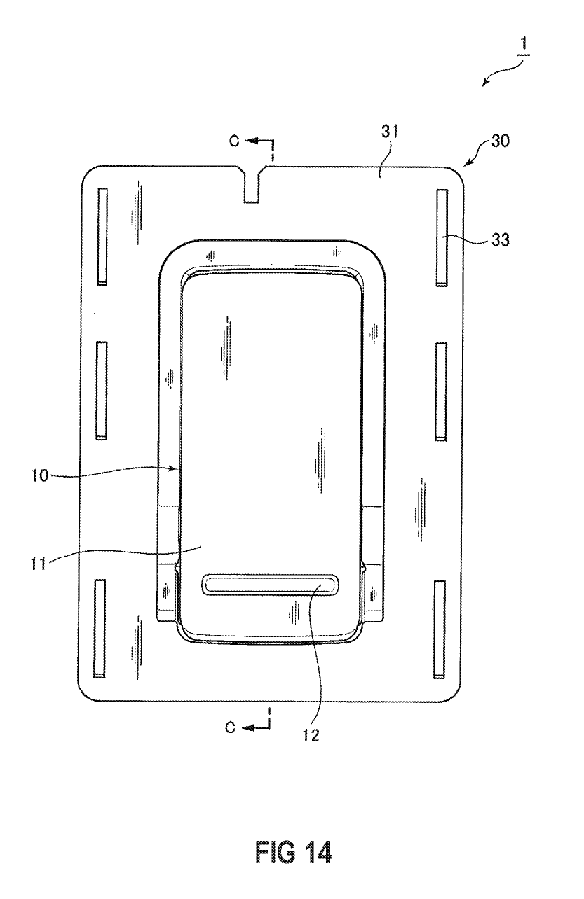

Also, in the present Specification, the up-and-down direction in FIG. 1, FIG. 7 and FIG. 14 will be called the vertical direction. The horizontal direction is the horizontal direction of these Figures. The depth direction is the depth direction of these Figures.

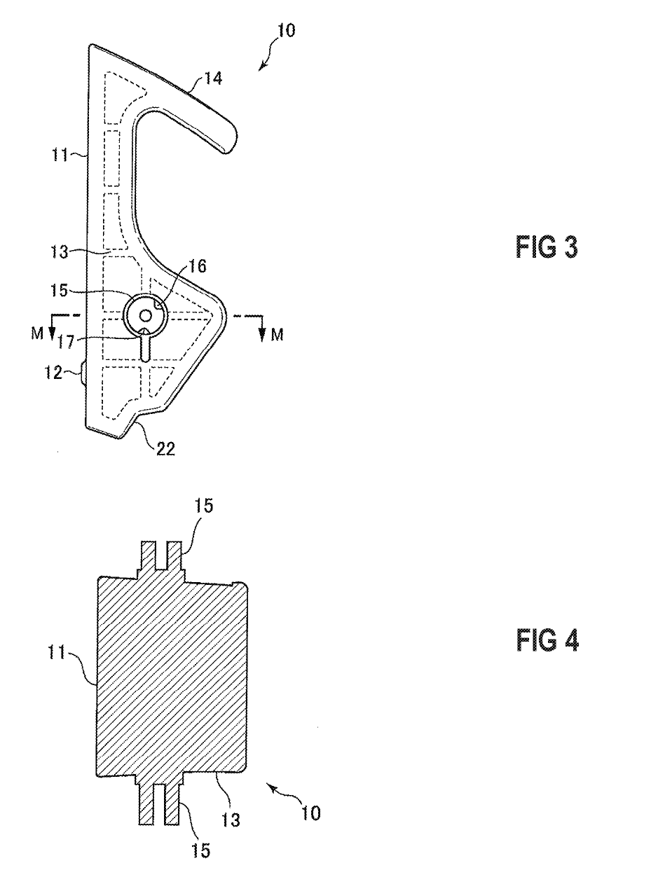

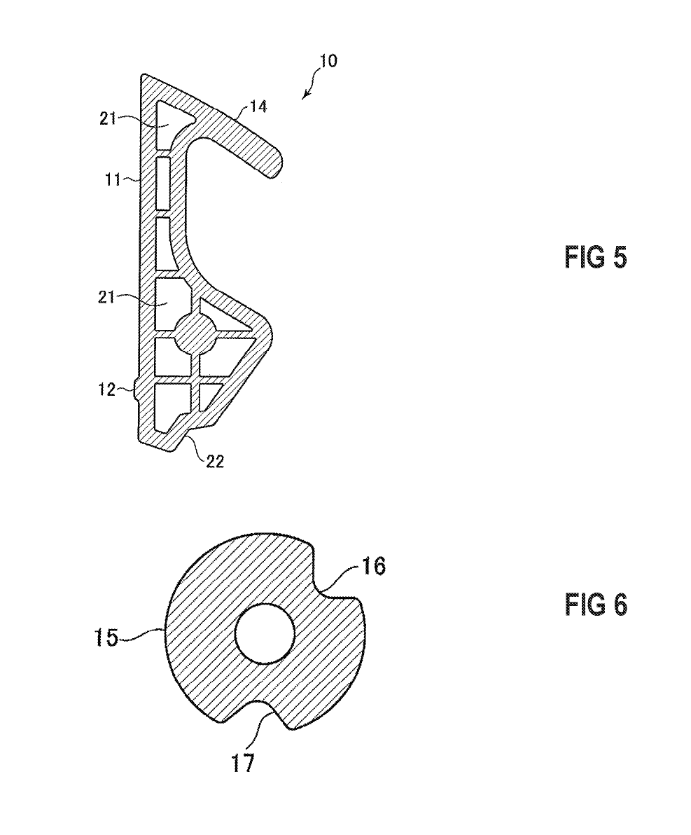

Hook 10 will be explained by referring to FIGS. 1-6. FIG. 1 is a front elevation view of hook 10 of the hook device for use in a vehicle 1 according to an embodiment of the present disclosure. FIG. 2 is a plan view, and FIG. 3 is a right side view. FIG. 4 is a sectional view along line M-M of FIG. 3 of hook 10. FIG. 5 is a sectional view along line L-L of FIG. 1 of hook 10. FIG. 6 is a sectional view along line N-N of FIG. 2 of hook 10. Hook 10 is made of plastic.

As shown in FIG. 1, the front of hook 10 has a roughly rectangular hook body 11. When the hook device for use in a vehicle 1 is attached in a vehicle interior, the front of hook body 11 is the part which can be seen at the surface. A long, rectangular elevated portion 12 is formed on the lower part of the front of hook body 11 in the horizontal direction. Hook 10 can be opened to the in-use position by pressing down on elevated portion 12 with a finger.

Hook side surfaces 13 extend from the left and right portions of the front of hook body 11.

As shown in FIG. 3, a tang 14 extends obliquely downward in the depth direction from the back of the top portion of hook body 11. A baggage handle or the like may be suspended from tang 14.

As shown in FIG. 1, a pair of hook shafts 15 are formed to the left and right at positions lower than the center of hook body 11 of hook 10. Hook shafts 15 are roughly cylindrical and extend in the horizontal direction. Blind holes are formed in the shaft centers of hook shafts 15.

Hook shafts 15 are supported by means of case bearing 37 of case 30 so as to rotate freely. Case bearing 37 of case 30 will be described below. When hook 10 is assembled with case 30, hook 10 can rotate between a housed position and an in-use position by using hook shafts 15 as shafts. In the housed position, hook 10 is housed in case 30, and in the in-use position, the tang 14 of hook 10 extends into the vehicle interior, and baggage and the like may be hung up.

As shown in FIG. 3 and in FIG. 6, a first groove 16 on each hook shaft 15 extends in the horizontal direction of the shafts. At a position in the circumferential direction which is different from that of first groove 16, a second groove 17 on hook shaft 15 extends in the direction of the central axes of hook shafts 15. As will be described below, when hook 10 is in the housed position in which hook 10 is housed in case 30, elastic tabs 43 of case 30 engage in first grooves 16. In the in-use position, in which tang 14 of hook 10 extends outwards, elastic tabs 43 of case 30 engage in second grooves 17.

As shown in FIG. 3 and in FIG. 5, a stopper receiving member 22 extends in the horizontal direction at the back surface of the lower part of hook body 11. When the hook device for use in a vehicle 1 is in the in-use state, stopper receiving member 22 abuts stopper 36 of case 30 and is held so that hook 10 cannot be opened from the in-use position.

As shown in FIG. 5, empty spaces 21 are formed inside hook 10 to render hook 10 lightweight. Empty spaces 21 are not formed in the portion between the pair of hook shafts 15.

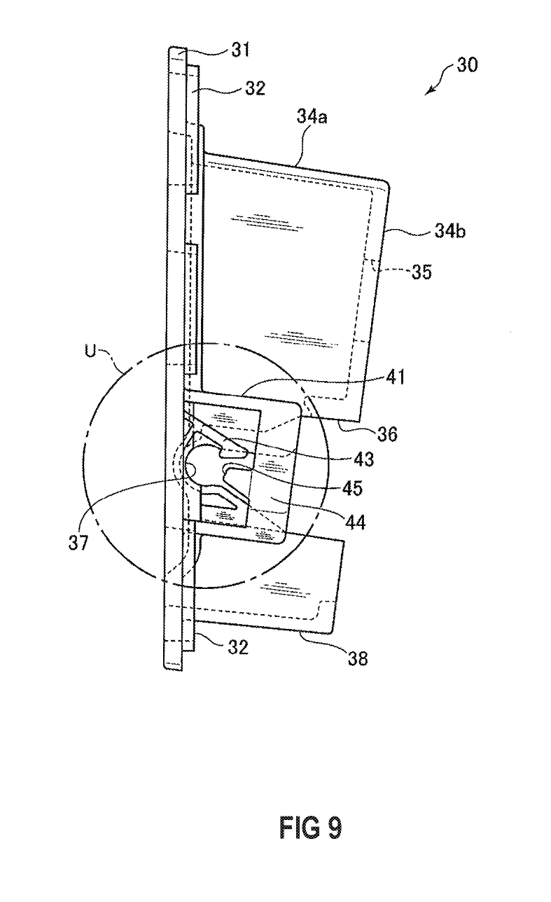

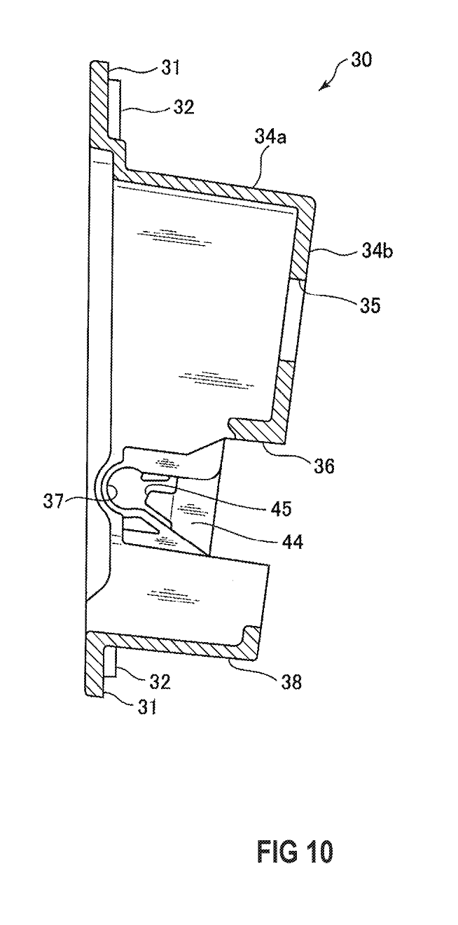

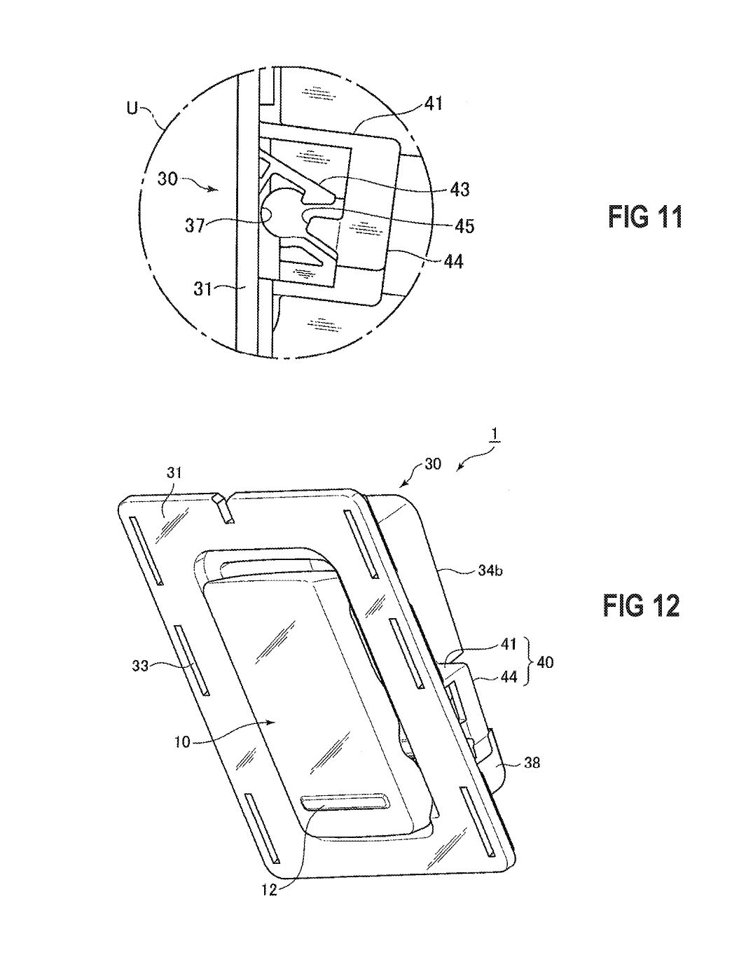

Case 30 of the hook device for use in a vehicle 1 according to an embodiment of the present disclosure will be explained by referring to FIGS. 7-11. Case 30 houses hook 10 in its interior and holds hook 10 so that it is capable of rotation. FIG. 7 is a front elevation view of case 30 of the hook device for use in a vehicle 1 according to the embodiment of the present disclosure. FIG. 8 is a plan view of case 30, and FIG. 9 is a right side view. FIG. 10 is a sectional view along line Q-Q of FIG. 7 of case 30. FIG. 11 is an enlarged view of the U portion of FIG. 9 of case 30. Case 30 is made of plastic.

The shape of case 30 is roughly rectangular, and it has a base 31 which is formed with a rectangular aperture. A raised portion 32, which is higher, extends in the vertical direction along the sides in the horizontal direction of base 31. A rectangular aperture 33 is formed in raised portion 32. The cross-section of rectangular aperture 33 is a rectangle which penetrates through from the surface of base 31 to the back surface of base 31. A raised portion of deck side trim 51 enters into rectangular aperture 33 so that case 30 can be attached to deck side trim 51.

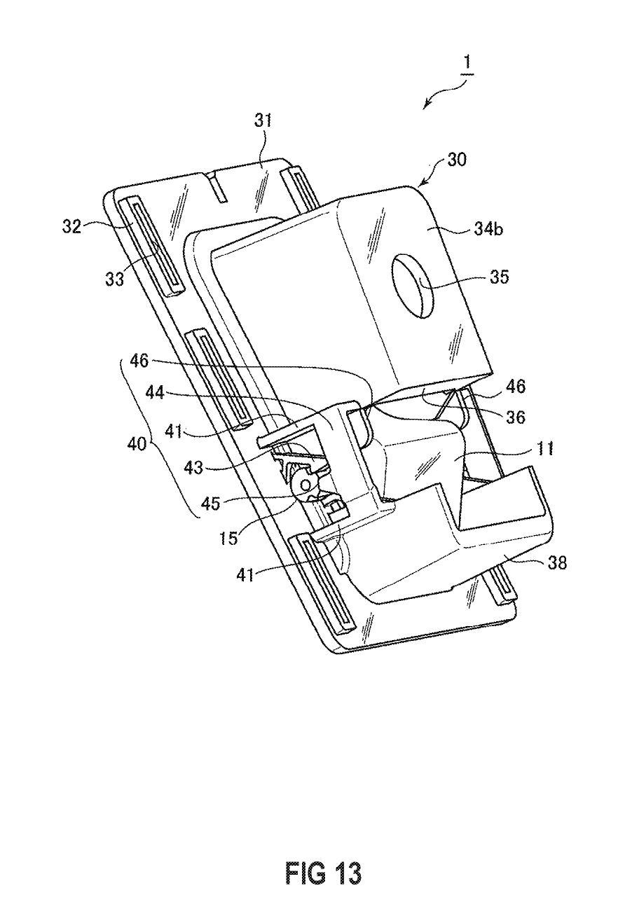

A box for containing hook 10 is formed on the back side of base 31 of case 30. The box is divided into an upper box 34 on top and a lower box 38 on the bottom. As shown in FIG. 9 and in FIG. 10, the upper box 34 for containing tang 14 of hook 10 is formed on the back side of the top portion of base 31. Upper box 34 is inclined towards base 31 and has a roughly rectangular parallelepiped configuration. As shown in FIG. 9 and in FIG. 13, upper box 34 has side surfaces 34a and a back surface 34b; a bolt aperture 35 penetrates through back surface 34b. As will be described below, bolt 60 passes through bolt aperture 35, enabling upper box 34 to be joined to an auto body 55 using nut 65.

As shown in FIG. 10, the lower end of back surface 34b is bent at a right angle to base 31 and becomes stopper 36. When hook 10 rotates as far as the in-use position, the stopper receiving member 22 of hook 10 is stopped when it abuts stopper 36.

A lower box 38 for containing hook body 11 of hook 10 is formed on the back side of the lower portion of base 31 shown in FIG. 7. The cross-section of lower box 38 is roughly U-shaped. Although lower box 38 has side surfaces, there is no back surface (the right side in FIG. 9), and the back side is open. The back side between upper box 34 and lower box 38 is also open. As will be described below, it may be assembled by inserting hook 10 between upper box 34 and lower box 38.

Referring to FIG. 11 and FIG. 13, a pair of shaft holding members 40 are formed on the right and left sides between upper box 34 and lower box 38. Shaft holding members 40 are placed so as to connect the side surfaces of upper box 34 and the side surfaces of lower box 38. The distance between the outer sides of shaft holding members 40 is greater than the width of upper box 34 and lower box 38 in the horizontal direction. The pair of shaft holding members 40 hold hook shafts 15 so they can rotate.

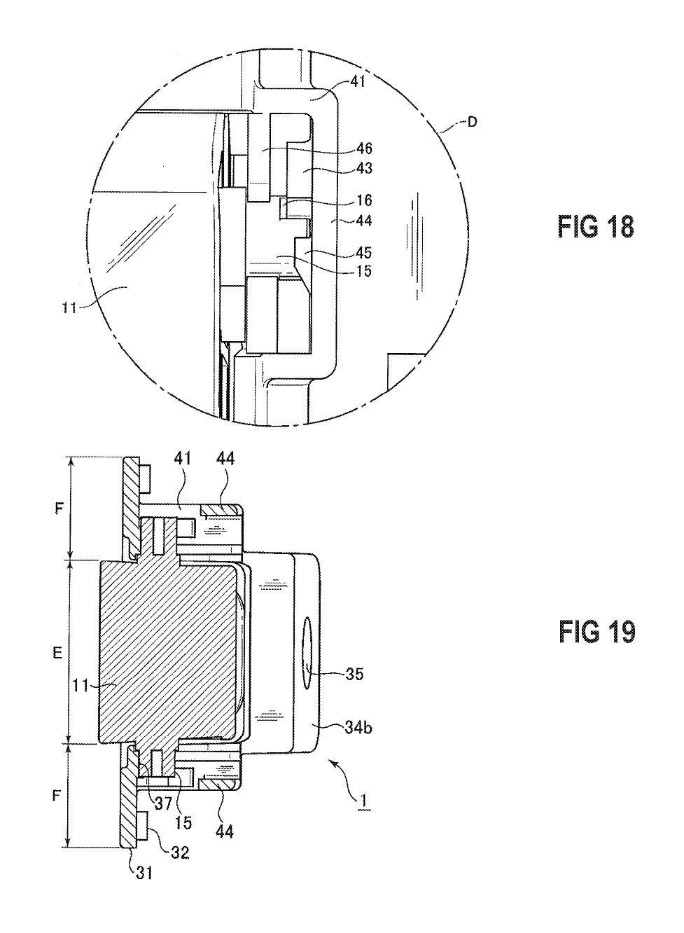

A shaft holding member 40 has two depth direction portions 41; a vertical direction portion 44 which connects the two depth direction portions 41; and a protuberance 45. As shown in FIG. 10, protuberance 45 extends from vertical direction portion 44 towards case bearing 37. As shown in FIG. 18, protuberance 45 abuts a position near the ends of hook shafts 15 in the horizontal direction.

As shown in FIG. 13, a horizontal direction control member 46 extends vertically from one of the depth direction portions 41. A pair of horizontal direction control members 46 abuts hook side surfaces 13 of hook 10, and these control hook shafts 15 from moving in the horizontal direction.

Each of the shaft holding members 40 comprises depth direction portions 41; an elastic tab 43; a vertical direction portion 44; a protuberance 45; and a horizontal direction control member 46.

As shown in FIG. 9 and in FIG. 10, a pair of recessed case bearings 37 are formed on the horizontal end of the back side of base 31, and these extend in the horizontal direction. These case bearings 37 are also included in shaft holding members 40. Case bearings 37 have an inner diameter which conforms to the outer diameter of hook shafts 15 of hook 10. When hook 10 is assembled in case 30, the tips of protuberances 45 abut hook shafts 15. Hook shafts 15 are supported by case bearings 37 and the tips of protuberances 45 so as to be capable of rotating.

As shown in FIG. 10 and in FIG. 11, a pair of elastic tabs 43 extends obliquely downward from the back side of base 31. Raised portions 43a are formed on the tips of elastic tabs 43.

When hook 10 is in the housed position, first grooves 16 of hook shafts 15 arrive at the position of raised portions 43a of elastic tabs 43. Raised portions 43a of elastic tabs 43 engage with first grooves 16, enabling hook 10 to be held in the housed position.

Also, when hook 10 is in the in-use position, second grooves 17 of hook shafts 15 arrive at the position of raised portions 43a of elastic tabs 43. Raised portion 43a of elastic tabs 43 engage in second grooves 17, enabling hook 10 to be held in the in-use position.

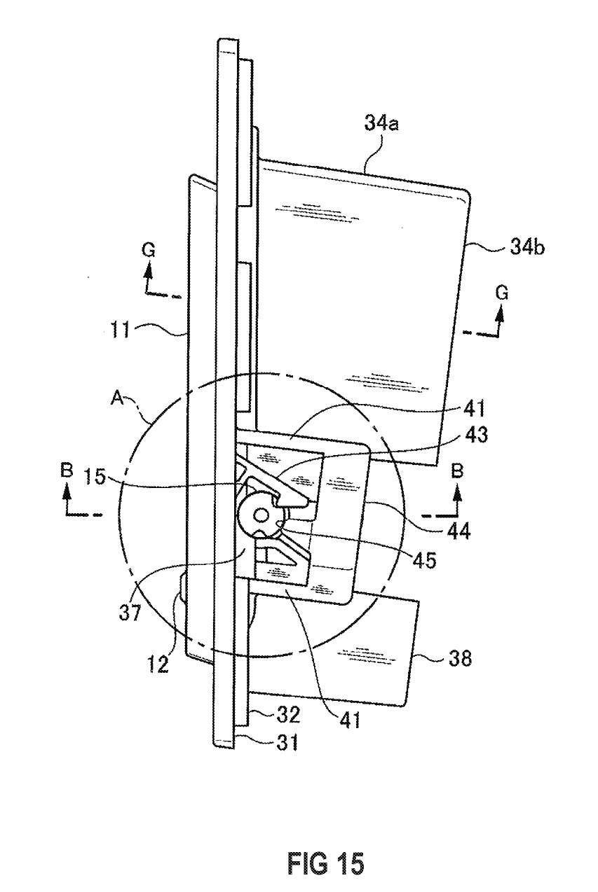

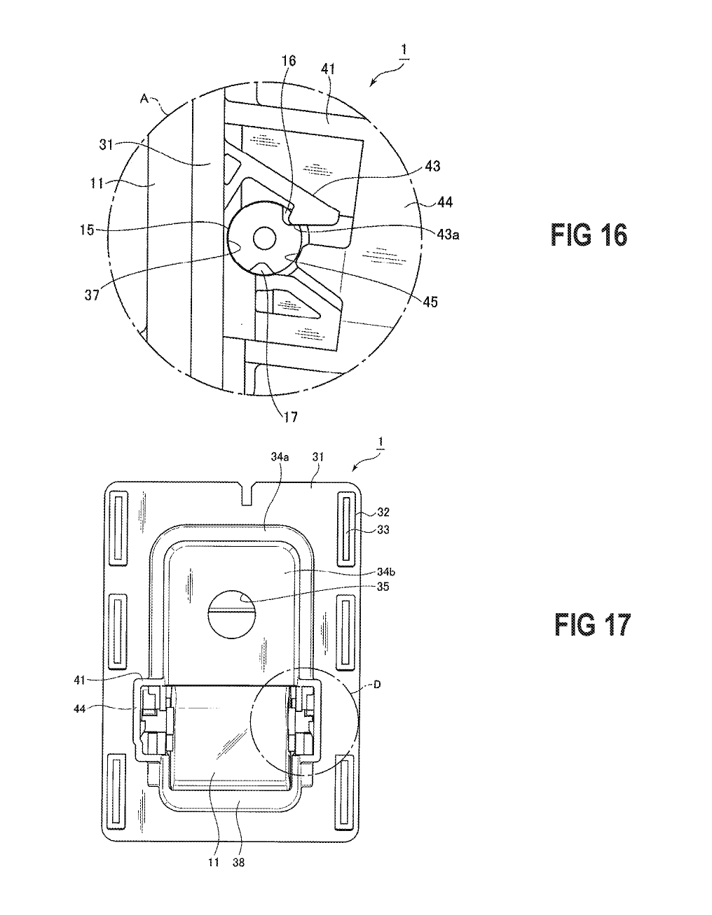

A hook device for use in a vehicle 1 will be explained in which hook 10 has been built into case 30. FIG. 12 is a perspective view of the hook device for use in a vehicle 1, and FIG. 13 is a perspective view seen from a different direction. FIG. 14 is a front elevation view of hook device for use in a vehicle 1, and FIG. 15 is a right side view. FIG. 16 is an enlarged view of portion A in FIG. 15. FIG. 17 is a rear view of the hook device for use in a vehicle 1. FIG. 18 is an enlarged view of portion D of FIG. 17. FIG. 19 is a sectional view along line B-B of FIG. 15.

FIG. 20 is a sectional view along line C-C of FIG. 14 and also shows deck side trim 51 and auto body 55. FIG. 21 is a sectional view along line G-G of FIG. 15.

As shown in FIG. 15 and in FIG. 16, hook shafts 15 of hook 10 are supported so as to be capable of rotating. Specifically, hook shafts 15 are received in case bearings 37. The tips of protuberances 45 abut hook shafts 15. Hook shafts 15 are rotatably supported by case bearings 37 and protuberances 45 so that they do not slip from case bearings 37. In addition, hook shafts 15 are also supported from the back side by elastic tabs 43.

When hook 10 is in the housed position, hook 10 enters a space enclosed by upper box 34 of case 30, shaft holding members 40 and lower box 38.

As shown in FIG. 15, the surface of hook body 11 of hook 10 is roughly parallel to the surface of base 31 of case 30. The surface of hook body 11 projects higher than the surface of base 31. When hook device for use in a vehicle 1 is attached to an auto body, the surface of base 31 of case 30 is covered by deck side trim 51 and is not visible from the outside. Hook body 11 of hook 10 is not covered by deck side trim 51, and is visible. The visible portion is shown by E in FIG. 19, and the portion which is not visible is shown by F.

As shown in FIG. 20, when the hook device for use in a vehicle 1 is attached to an auto body, deck side trim 51 and the surface of hook body 11 are roughly coplanar.

As shown in FIG. 15 and in FIG. 16, when hook 10 is in the housed position, elastic tabs 43 of case 30 enter first grooves 16 of hook shafts 15 of hook 10 and hook 10 is held so that hook 10 cannot be opened easily from the housed position.

By pressing on elevated portion 12, hook 10 rotates around hook shafts 15 as a center shaft, and elastic tabs 43 come out of first grooves 16 of hook shafts 15. Tang 14 comes out of upper box 34 of case 30.

When hook 10 rotates, the pair of horizontal direction control members 46 control hook shafts 15 from slipping in the horizontal direction.

Hook 10 is shown in the in-use position by the broken line with two dots in FIG. 20. When hook 10 rotates as far as the in-use position, elastic tabs 43 of case 30 enter second groove 17 of hook shafts 15. A crisp, snap-in feel can be perceived at that time. Hook 10 is held so that it cannot be closed easily from the in-use position.

In the in-use position, stopper receiving member 22 abuts stopper 36 of case 30, and hook 10 is held so that it cannot open by again rotating from the in-use position. By means of stopper 36 abutting with stopper receiving member 22, an item with a degree of weight may be suspended from tang 14.

A baggage handle suspended on tang 14 is shown in cross-section by broken line P.

When the hook device for use in a vehicle 1 is no longer in use, hook 10 is rotated and pushed into upper box 34 of case 30. When it is pushed as far as the housed position, elastic tabs 43 enter first grooves 16 of hook shafts 15, and a crisp, snap-in feel can be achieved. Hook 10 is held in the housed position until elevated portion 12 of hook 10 is pressed in order to rotate it and use it the next time.

A hook device for use in a vehicle 1 consists of a hook 10 built into a case 30. Hook 10 is inserted through the space between upper box 34 of case 30 and lower box 38, with tang 14 inserted first.

As shown in FIG. 17 and in FIG. 18, the distance between the tips of hook shafts 15 is slightly larger than the distance between the pair of protuberances 45. For that reason, the tips of hook shafts 15 push and widen the pair of protuberances 45 in the horizontal direction, and hook shafts 15 are inserted in case bearings 37. When hook shafts 15 are inserted, the two protuberances 45 return to their original position, and hook shafts 15 are held so that they do not slip.

By pressing on elevated portion 12 of hook 10, hook 10 is rotated as far as the in-use position, and bolt 60 with attached washer 64 passes through bolt hole 35 of case 30.

Case 30 is attached to an attachment hole of auto body 55 by means of bolt 60 and nut 65.

Next, hook 10 is closed in the housed position. Deck side trim 51 is attached by inlaying the raised portion of deck side trim 51 in the rectangular aperture 33 of base 31 of case 30.

Deck side trim 51 covers the surface of base 31 of case 30, and hook body 11 of hook 10 is not covered. The surface of hook body 11 comes out in the open portion of deck side trim 51. In the hook device for use in a vehicle 1, only the surface of hook body 11 can be seen, which makes it desirable as regards its appearance. Hook shafts 15, case bearings 37, and the locking mechanism of elastic tabs 43 and the like, are at the back of base 31 of case 30 and are not visible from the outside. In addition, stopper 36 and stopper receiving member 22 are not visible from the outside, either.

According to the embodiment of the present disclosure, a locking mechanism for locking a hook in an in-use position and in a housed position enables achieving a lock for vehicle use which is not visible from the outside and which looks attractive.

Also, it is possible to obtain a lock for vehicle use which has a locking mechanism with a simple structure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hook device for use in a vehicle comprising:
a case having a base with a box formed on the back side of the base and shaft holding members which are provided on the horizontal sides of the base; and
a hook which is provided with a hook body and a tang for holding baggage, and hook shafts which are held at the shaft holding members, capable of rotating around the hook shafts as a center shaft between a housed position in which it is housed in the box of the case, and an in-use position in which the tang extends out to hold baggage;
wherein the hook shafts have first grooves and second grooves which extend in the direction of the central axes of the hook shafts; and
wherein the shaft holding members of the case are comprised of case bearings which are provided on the back side of the base for receiving hook shaft and elastic tabs which can engage in the first grooves or in the second grooves of the hook shafts; and
wherein the elastic tabs engage in the first grooves in the housed position and engage in the second grooves in the in-use position.

2. A hook device for use in a vehicle as set forth in claim 1, wherein the elastic tabs in the shaft holding members extend from the back side of the base and contact the hook shafts at positions other than those of the case bearings.

3. A hook device for use in a vehicle as set forth in claim 1, wherein the shaft holding members of the case have a pair of protuberances which hold the hook shafts from the side opposite the case bearings so that the hook shafts do not slip from the case bearings.

4. A hook device for use in a vehicle as set forth in claim 1, wherein the surface of the hook body of the hook is higher than the surface of the base of the case when the hook is in the housed position, and the surface of the base of the case is covered by the deck side trim of the vehicle when the device is built into a vehicle.

5. A hook device for use in a vehicle as set forth in claim 1, wherein the box of the case is comprised of an upper box which has side surfaces and a back surface, and a lower box which has side surfaces but does not have a back surface.

6. A hook device for use in a vehicle as set forth in claim 1, wherein the upper box of the case has a stopper; and
wherein the hook has a stopper receiving member which the stopper abuts; and
wherein the stopper abuts the stopper receiving member in the in-use position to hold the hook so it does not rotate beyond the in-use position.

7. A hook device for use in a vehicle as set forth in claim 5, wherein a bolt hole is formed on the back surface of the upper box to allow a bolt to pass through.
